(19) United States
(12) Patent Application Publication
(10) Pub. No.: US 2005/0081598 A1
(43) Pub. Date: Apr. 21, 2005

(54) Method and apparatus for calibrating seal force testing devices

(76) Inventors: Bruno Tongiani, Phoenixville, PA (US); James Day, Feasterville, PA (US)

Correspondence Address: Eugene E. Renz, Jr. P.C., 205 North Monroe Street, Post Office Box 2056, Media, PA, 19063-9056, US

(21) Appl. No.: 10/965,068

(22) Filed: Oct. 14, 2004

Related U.S. Application Data
(60) Provisional application No. 60/512,425, filed on Oct. 17, 2003.

(51) Int. Cl. G01G 19/56

(52) U.S. Cl. 73/1.08

(57) ABSTRACT

A compression calibration tester comprises as its main parts, a plunger, a base, and a spring. The compression calibration tester provides a known force. This known force is used to calibrate, and ensure proper operation of a seal force testing device. The seal force testing device is used to seal containers. Typically, these containers are used to store parenteral pharmaceutical products. Testing of the residual seal force of the closure is an important step in the package development and production of parenteral pharmaceutical products. This invention is useful for ensuring that a seal force testing device is operating properly.

This application claims the benefit of U.S. Provisional Patent Application No. 60/512,425 filed Oct. 17, 2003, incorporated by reference herein.

### FIELD OF THE INVENTION

The present invention relates to method and apparatus for calibrating a seal force testing device. More specifically, the present invention relates to a method and apparatus for quantitatively confirming the setup of a seal force testing device. The seal force testing device is typically used to test containers which hold pharmaceutical products, and therefore, it is desirable to calibrate the seal force testing device using a quantitative method that is repeatable, and can be validated independently.

### BACKGROUND OF THE INVENTION

Parenteral (injectable) pharmaceutical products are usually packaged in glass containers with a closure comprising a resilient sealing element held in place over the open end of the container by a cap. The cap usually is composed of aluminum, but may be composed of other materials. In the pharmaceutical packaging process, an apparatus applies a force to the resilient member, compressing the resilient member between a flange of the container and the cap. A skirt of the cap is crimped around the flange of the container. The cap thereby maintains a force on the resilient member, compressing the resilient member, sealing the container and protecting the pharmaceutical product against contamination.

The force exerted by the resilient member on the cap and container flange of a sealed container, and hence by the cap and container flange on the resilient member, is hereinafter referred to as the “residual seal force” (“RSF”). The compression of the resilient member in response to the residual seal force is hereinafter referred to as the “residual compression.” Maintenance of an adequate residual seal force and hence a proper residual compression of the resilient member is important to maintaining a proper seal and to protecting the integrity of the pharmaceutical product enclosed within the container.

For purposes of this application, the term “closure” is an assembly comprising the flange of the container, the resilient member covering the opening of the container and the cap compressing the resilient member and thereby sealing the container. A “closure” may include a removable button allowing access to the resilient member so that a syringe may be inserted into the container, providing access to the parenteral pharmaceutical product.

A seal force testing device is used for determining the residual seal force. An automated press moves an anvil against the closure of a sealed container. The press automatically records distance as the anvil moves. At prescribed distances, the press automatically records the force applied to the anvil by the closure. The resulting data set comprises a sequence of data points for strain data (displacement of the closure) and stress data (force exerted by the closure in response to the strain). The data points can be plotted on a graph, approximating a stress-strain curve.

Stress-strain curves for the testing of parenteral container closures follow a predictable pattern. At the point at which the force exerted by the press overcomes the residual force exerted by the residual compression of the resilient member, the stress vs. strain graph shows an inflection point, referred to as a “knee”, resulting from a reduction in slope. The stress at the knee of the stress-strain curve therefore defines the residual seal force.

Testing of the residual seal force of the closure is an important step in the package development and production of parenteral pharmaceutical products. It is therefore desirable to have an apparatus and method for calibrating a seal force testing device in an accurate, efficient, and repeatable manner.

The disclosure of U.S. Pat. Nos. 4,511,044 and 6,615,672 are incorporated by reference herein, to the extent not inconsistent herewith.

### SUMMARY OF THE INVENTION

The present invention relates to method and apparatus for calibrating a seal force testing device (SFTD). The apparatus of the present invention, referred to hereinafter as the Compression Calibration Tester (CCT), is used to calibrate a seal force testing device. To calibrate the SFTD, the CCT is inserted into the SFTD in place of a container. The CCT provides a known resistance which can be used to verify the operation of the SFTD.

One feature of the present invention is a CCT that is suitable for use in an SFTD, in place of a container. Another feature of the present invention is a CCT which provides a member having minimal deflection when compressed to a predetermined force limit, and then deflects considerably once the predetermined force limit has been exceeded. Yet another feature of the present invention is an adjustment capability for adjusting the predetermined force limit of the CCT.

### BRIEF DESCRIPTION OF THE DRAWINGS

FIG. 1A shows a plan view of an exemplary embodiment of a compression calibration tester of the present invention.

FIG. 1B shows a perspective view of an exemplary embodiment of a compression calibration tester of the present invention.

FIG. 2 shows the compression calibration tester as used in a seal force testing device.

FIG. 3 shows an exemplary plot of a mathematical relationship between force and displacement.

### DESCRIPTION OF THE PREFERRED EMBODIMENTS

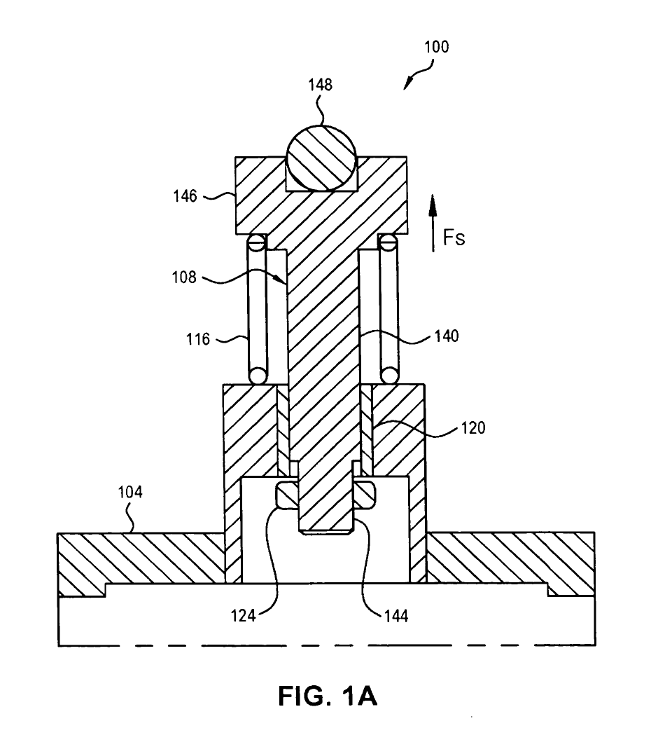

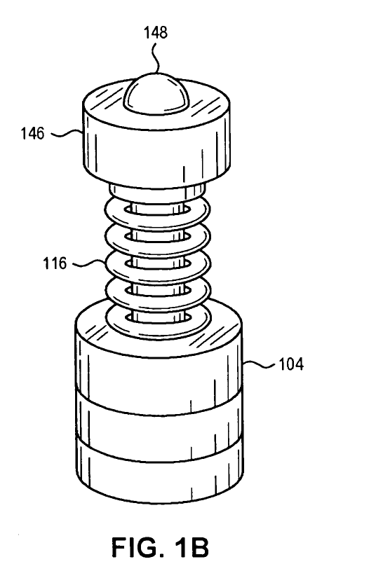

FIG. 1A shows a plan view of an exemplary embodiment of a compression calibration tester (CCT) of the present invention, indicated as reference 100. The CCT has three primary parts; the base 104, the plunger 108, and spring 116. In one embodiment, spring 116 is made of 17-7 CRES (corrosion resistant steel), which is a typical metal used in spring manufacturing. The spring could be made from other materials as longs as it exhibits the same characteristics. The base 104 is preferably cylindrical, and has friction reducing bushing 120 in the center. In one embodiment, the bushing 120 is made from ultra-high molecular weight polyethylene (UHMWPE). This material, combined with a smooth finish on the shaft of the plunger 108 produces a very low coefficient of friction. This eliminates the need for lubrication between bushing 120 and plunger 108.

Plunger 108 is comprised of shaft 140, head 146, top 148, and bottom 144. Top 148 is spherical, providing the advantage of eliminating side loading caused by any forces applied to the CCT. Spring 116 is made of a resilient material, such as metal, and formed into a coil. The coil has a diameter of sufficient size as to allow the plunger to pass through the coil. In assembling the CCT, the plunger 108 is placed through spring 116, and plunger bottom 144 protrudes from the underside of base 104. The head 146 is of sufficient width to exceed the diameter of the coil, allowing the spring to rest against the bottom of head 146. Plunger bottom 144 contains threads for receiving adjusting nut 124. Adjustment nut 124 serves as a limiter, which limits upward vertical travel of plunger 108. While the embodiment shown uses adjustment nut 124 as a limiter, it would be possible to use another type of limiter, such as a locking pin, without departing from the scope of the invention. The adjustment nut 124 is fastened to the plunger bottom 144 via threads on plunger bottom 144. Turning adjusting nut 124 in a tightening direction causes the plunger head 146 to be moved closer to base 104. This increases the force exerted by spring 116 in the direction indicated by Fs. FIG. 1B shows CCT 100 from a perspective view.

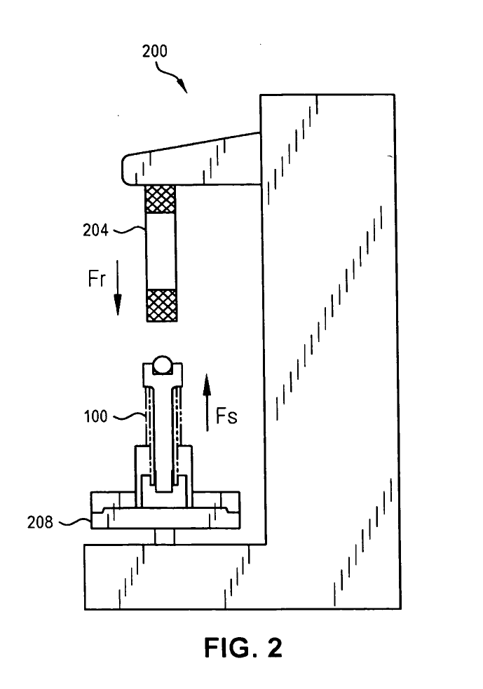

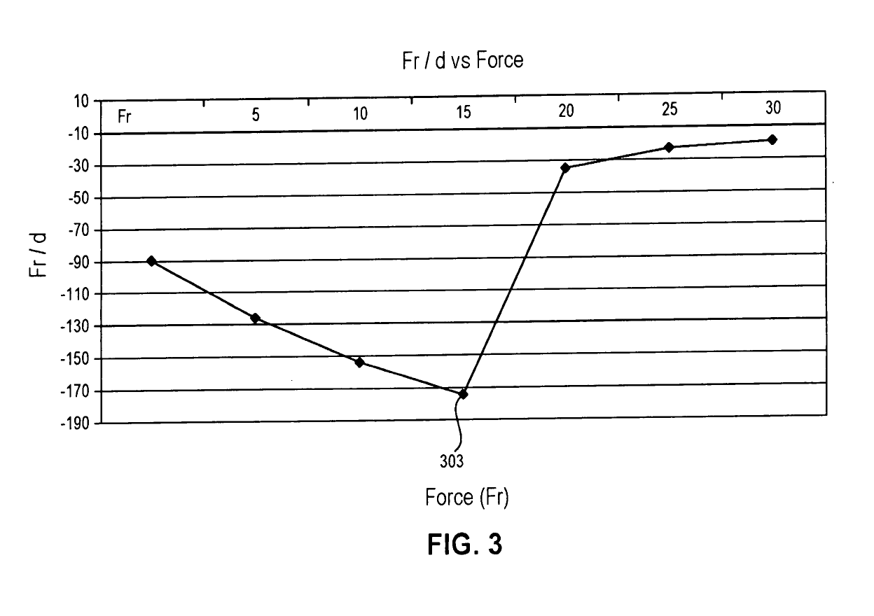

FIG. 2 shows the compression calibration tester (CCT) 100 as used in a seal force testing device (SFTD), indicated as reference 200. The SFTD 200 has extension rod 204 that applies a predetermined force to the top of a container during normal operation, and container rest pad 208, that supports the container from underneath. To calibrate the SFTD, the CCT 100 is placed on the container rest pad 208, in place of a normal container. The CCT 100 is adjusted to provide a specific resistive force. To begin the calibration process, the extension rod 204 is lowered to make contact with, and exert force upon CCT 100. The SFTD 200 measures the force exerted by the extension rod, indicated by Fr, and the amount of travel of extension rod 204. This travel distance is referred to hereinafter as deflection (d). The SFTD 200 monitors the ratio Fr/d. Considering a CCT set to predetermined force Fs, when Fr is less than Fs, the ratio Fr/d is large, because d is very small. Once the extension rod 204 increases force Fr such that it overcomes Fs, the deflection d quickly increases, and the ratio Fr/d exhibits a rapid decrease. This decrease appears as an inflection point when the value of Fr/d is graphed for a range of values of Fr which includes Fr values both below and above Fs. This mathematical relationship will be referred to hereinafter as the Fr/d curve. An exemplary Fr/d curve is shown in FIG. 3. The data point represented by reference 303 indicates the inflection point or “knee” of the Fr/d curve. The SFTD 200 records the value of Fr at the aforementioned inflection point of the Fr/d curve. The value of Fr should theoretically be equal to Fs at the inflection point of the Fr/d curve. In practice, the value of Fr should fall within an acceptable range above or below Fs. If Fr is out of this range, the SFTD 200 requires calibrating to operate properly. SFTD 200 may perform additional mathematical analysis of the Fr/d curve to further refine the process of identifying the inflection point. For example, a first or second derivative of the Fr/d curve may be used to better identify the inflection point. Various methods that may be employed by SFTD 200 for identifying the inflection point are detailed in U.S. Pat. No. 6,615,672, which is incorporated herein by reference.

Operation

Before using the CCT 100, it is preferable to independently calibrate it. This typically entails checking the spring force against a reference standard, such as a NIST traceable standard. The adjusting nut 124 is turned to place the plunger at the proper position relative to the base to create the desired spring force Fs. Then, a sealing means is applied to the adjusting nut to indicate it has been calibrated, and provide evidence of any tampering or accidental movement. This sealing means may be in the form of a sticker placed over the adjustment nut 124, and also over a portion of base 104. Alternatively, epoxy or wax can be applied to adjustment nut 124 to ensure it remains in the proper position. Once calibrated, the CCT 100 is placed on container rest pad 208. The extension rod 204 is lowered onto the CCT 100, making contact with plunger top 148. The extension rod 204 exerts force Fr against the CCT 100. Spring 116 exerts opposing force Fs on the plunger head 146. The SFTD 200 increases force Fr until it overcomes force Fs. The SFTD reports the required extension rod force Fr used to overcome spring force Fs.

Accordingly, the reader will see that the method and apparatus disclosed can conveniently provide an accurate and repeatable way to calibrate a seal force testing device. Although the descriptions above contain many specific details, these should not be construed as limiting the scope of the invention, but merely as providing illustrations of some of the presently preferred embodiments of this invention. Thus the scope of the invention should be determined by the appended claims and their legal equivalents, rather than by the examples given.

Even though a particular embodiment of the invention has been illustrated and described herein, changes and modifications may be made therein within the scope of the following claims.

1. A tool for calibrating a seal force testing device comprising;
a. a plunger comprising an elongated member having a top and a bottom end, a head affixed to the top of said elongated member, and fastening means at the bottom end of said elongated member, said head being wider than said elongated member;
b. a base comprising a cylindrical portion having an underside with a recess therein, and having an opening through which said elongated member passes;
c. a coil spring having a central opening through which said elongated member passes, said coil spring being compressed between said head of said plunger, and said base with a selected compressive force, and
d. a limiter fastened to the bottom end of said elongated member via said fastening means, said limiter being adapted to limit the upward travel of said plunger.

2. The tool of claim 1, wherein said head of said plunger further comprises a spherical top portion, whereby the spherical top eliminates side loading caused by off-axis forces applied to said plunger.

3. The tool of claim 1, wherein said base further comprises a bushing circumscribing said center opening of said base, whereby said bushing reduces friction between said plunger and said base.

4. The tool of claim 1, wherein said fastening means at said bottom end of said elongated member of said plunger comprises a threaded portion of said elongated member, and said limiter is a nut, whereby the compressive force of said spring is adjusted by turning the said nut around said threaded portion of said elongated member of said plunger.

5. A method for calibrating a tool of claim 4, comprising the steps of selecting a desired compressive force, compressing the spring to the desired force and noting the displacement of the spring, turning the adjustment nut to the position that causes the spring to be displaced to the amount that provides the selected compressive force, and applying a sealing means to the adjustment nut.

6. A method for calibrating a seal force testing device having an extension rod, comprising the steps of:
a. Providing a tool of claim 1, adjusted to provide a selected compressive force;
b. Applying a force to the tool of claim 1 with the extension rod of the seal force testing device;
c. Reading the applied force reported by the seal force testing device at the instant the ratio of applied force of the extension rod to the distance traveled by the extension rod decreases sharply;
d. Comparing said applied force reported by the seal force testing device with the selected compressive force of the tool; and
e. Adjusting the seal force testing device such that the applied force reported by the seal force testing device at the instant the ratio of applied force of the extension rod to the distance traveled by the extension rod decreases sharply is approximately equal to the selected force of the tool.
